(19) United States
(12) Patent Application Publication
(10) Pub. No.: US 2018/0229626 A1
(43) Pub. Date: Aug. 16, 2018

(54) LONGITUDINAL ADJUSTMENT DEVICE FOR A VEHICLE SEAT AND VEHICLE SEAT

(71) Applicant: Adient Luxembourg Holding S.à.r.l., Luxembourg (LU)

(72) Inventors: Erik SPRENGER, Wermelskirchen (DE); Maros ROVNY, Trencin (SK)

(21) Appl. No.: 15/514,972

(22) PCT Filed: Sep. 1, 2015
(86) PCT No.: PCT/EP2015/069903

§ 371 Date: Mar. 28, 2017

(30) Foreign Application Priority Data
Sep. 30, 2014 (DE) 10 2014 219 868.2
Jul. 31, 2015 (EP) PCT/EP2015/067621

(51) Int. Cl. B60N 2/08

(52) U.S. Cl. CPC B60N 2/0818; B60N 2/0887; B60N 2/0875

(57) ABSTRACT

A vehicle seat longitudinal adjustment device (1, 10) includes a seat rail (2.1, 20.1) secured to the vehicle and a seat rail (2.2, 20.2) attached to the seat, which mutually engage to form a rail profile and move in relation to one another in a longitudinal direction, a rail lock (3, 30) to lock the seat rails to one another; and an actuation assembly (4, 40) for actuating the rail lock. An adapter (5, 50) is arranged between the actuation assembly and the rail lock. The adapter is configured as a force transmission element with a connection region (5.1, 50.1) that protrudes from the rail profile for connecting the actuation assembly. An integrated unlocking element (5.6, 50.6) is provided on the adapter for unlocking the rail lock. The unlocking element is configured to operatively engage in the rail lock, when the actuation assembly is actuated, in order to unlock same.

### CROSS REFERENCE TO RELATED APPLICATIONS

This application is a United States National Phase Application of International Application PCT/EP2015/069903, filed Sep. 1, 2015, and claims the benefit of priority under 35 U.S.C. § 119 of German Application 10 2014 219 868.2, filed Sep. 30, 2014, and International Application PCT/EP2015/067621, filed Jul. 31, 2015, the entire contents of which are incorporated herein by reference.

### FIELD OF THE INVENTION

The invention relates to a longitudinal adjustment device for a vehicle seat, and to a vehicle seat with a longitudinal adjustment device of this kind.

### BACKGROUND OF THE INVENTION

A longitudinal adjustment device of the type mentioned is known from DE 10 2006 021 884 B3, for example. In the latter, a first seat rail connected to the vehicle structure and a second seat rail connected to the seat structure are provided which mutually engage and are movable relative to each other in the longitudinal direction. Moreover, a rail lock, which is arranged substantially inside the rail profile, and an unlocking flap, which is arranged outside the rail profile and acts on the rail lock when actuated, are provided. DE 10 2008 058 518 A1 discloses an actuation assembly for a rail lock, which is inserted from outside into an opening in the seat rail via a lever.

U.S. Pat. No. 7,314,204 B2 and DE 203 11 948 U1 disclose longitudinal adjustment device which have a locking device arranged inside the rail profile.

### SUMMARY OF THE INVENTION

An object of the present invention is to specify an improved longitudinal adjustment device for a vehicle seat, and also a vehicle seat having an improved longitudinal adjustment device of this kind.

The longitudinal adjustment device according to the invention for a vehicle seat comprises at least one seat rail secured to the vehicle and one seat rail secured to the seat, which mutually engage to form a rail profile and are movable relative to each other in the longitudinal direction, and are lockable to each other by means of a rail lock, and at least one actuation assembly for actuating the rail lock, wherein at least one adapter is arranged between the actuation assembly and the rail lock, said adapter being configured as a force transmission element in such a way that at least one integrated connection region of the adapter protrudes from the rail profile in order to connect the actuation assembly, and at least one integrated unlocking element of the adapter is provided in order to unlock the rail lock.

In one possible embodiment, the integrated connection region for connection of the actuation assembly protrudes perpendicularly from an upper seat rail, in particular from a slit-shaped recess in the upper seat rail. The actuation assembly is secured on this connection region, protruding perpendicularly from the upper seat rail, for conjoint rotation therewith, such that a pivoting of the actuation assembly leads to a pivoting of the connection region, as a result of which the rotation point of the actuation assembly is formed in the connection region of the adapter. For this purpose, at least the connection region of the adapter can be formed from a spring steel sheet.

Furthermore, the adapter can optionally be configured as a force transmission element in such a way that at least two differently configured actuation assemblies can be secured on the adapter, in particular in a releasable manner.

A longitudinal adjustment device of this kind is universally usable and permits both a use with internal actuation, in particular with an internally engaging operating lever, and also with external actuation, in particular with an externally engaging operating lever. Moreover, a longitudinal adjustment device of this configuration is suitable for rail arrangements both with a high and also a low rail profile. Moreover, a longitudinal adjustment device of this kind is independent of the nature and configuration of the rail lock and is thus suitable for adaptation of any kind of rail lock.

In one embodiment, provision is made that the adapter is arranged inside the rail profile formed by the seat rails and protrudes at least in parts from the rail profile. By virtue of the configuration of the adapter as a force transmission element and the internal arrangement of the adapter, a compact, simple and protected arrangement is afforded. In particular, the space requirement for the actuation is minimized.

In a further embodiment, provision is made that the adapter has at least two connection regions, which are each configured corresponding to one of the differently configured actuation assemblies. An adapter of this configuration permits simple adaptation and integration of differently configured actuation assemblies on one longitudinal adjustment device and, consequently, a modular longitudinal adjustment device. In this case, the actuation assembly can be configured as an operating lever or operating yoke. For example, the actuation assembly can be configured as a transverse rod with a welded-on metal grip or with a mechanically connected plastic grip or a transverse rod with a welded-on yoke, in particular a U-shaped yoke, or as a separate one-part yoke, in particular a U-shaped yoke.

In a development of the invention, provision is made that an inner connection region of the adapter is arranged inside the rail profile formed by the seat rails, extends in the longitudinal orientation of the seat rails and is configured to receive and retain an actuation assembly inserted internally into the rail profile. The adapter, on the side facing toward the actuation assembly, is connected to this actuation assembly with form-fit and/or force-fit engagement. On the other side of the adapter lying opposite the actuation assembly, the adapter is configured in such a way that, upon actuation of the actuation assembly, it engages with the rail lock in order to unlock same. In the unactuated position of the actuation assembly, the lock-side end in question is provided with an integrated unlocking element and arranged at a distance from the rail lock. Thus, the adapter can be used for any type of rail lock and can also be integrated in already existing longitudinal adjustment device. A conventional unlocking lever can thus be omitted. Moreover, no additional conventional foot cover is needed. The space requirement is thus minimized and the costs reduced. Moreover, additional recesses in the rail profile are avoided, and the strength is thereby increased, and a symmetrical structure of the rail pair is permitted. In this case, preferably for reasons of symmetry, two adapters are arranged, one in the left-hand rail arrangement and one in the right-hand rail arrangement of the rail pair, wherein the two adapters are connected to each other via the actuation assembly.

Furthermore, provision is made that an outer connection region of the adapter protrudes from the rail profile perpendicularly with respect to the longitudinal orientation of the seat rails and is configured to receive and retain an actuation assembly arranged externally on the rail profile. For this purpose, for example, the upper seat rail is provided with a recess. In this way, an externally engaging operating lever can be secured easily with form-fit and/or force-fit engagement on the outer connection region, for example by being latched in the manner of a press-fit or snap-fit connection. A conventional welded connection can thus be safely avoided.

According to a further embodiment, the adapter is configured as a force transmission element in such a way that the rotation point of the actuation assembly is formed in the area of the seat-side seat rail. Thus, the rotation point of the actuation assembly is offset inward from the latter toward the adapter and permitted. For this purpose, the adapter is arranged pivotably on the seat-side seat rail.

To ensure that the actuation assembly comes automatically to its passive position or rest position, in which it interacts with the rail lock in a non-unlocking manner, the actuation assembly is arranged with spring loading on the adapter. For this purpose, a spring means is provided which pretensions the actuation assembly in the passive position. Furthermore, this spring means prevents the occurrence of rattling noises in the passive position through loose retention of the actuation assembly.

In one possible embodiment, the adapter is configured as a partially open, for example U-shaped, or closed profile. In this way, an actuation assembly inserted from the front into the rail profile can be inserted easily and safely into the internally located adapter and can be fixed in the latter with form-fit and/or force-fit engagement. Furthermore, at least one connection arm in the form of a retaining tab or retaining lug issues perpendicularly from the adapter, in particular from the profile as base element, on which an externally engaging actuation assembly can be fixed with form-fit and/or force-fit engagement. The adapter can in this case have a one-part or multi-part design. Thus, the profile can be made of metal and the connection arm of plastic. Alternatively, the adapter can be configured as a one-part plastic or metal component.

In a further embodiment, provision is made that the adapter is configured as a double-walled shaped part. For example, the adapter can be formed from a single shaped part which has a mirror-symmetrical design and is folded along an axis of symmetry, as a result of which two walls bearing on each other are formed. Alternatively, the adapter can be formed from two identical parts or walls which are connected to each other.

Furthermore, the adapter is configured in such a way that the walls bear on each other in the connection region. In the area of the unlocking element, the walls are spaced apart from each other. For this purpose, the walls are widened in the area of the integrated unlocking element and form the latter, which then engages on the rail lock.

Moreover, the adapter is configured in such a way that, from the walls bearing on each other, at least two tab-shaped retaining lugs protrude outward and away from each other. These retaining lugs are held in rail receivers that are shaped corresponding to them.

A vehicle seat preferably has the longitudinal adjustment device according to the invention, wherein two rail pairs are generally arranged on the vehicle seat, each with an upper rail and a lower rail, and an adapter and a rail lock interacting with the latter are each arranged in the rail profiles thereof, wherein a common actuation assembly interacts with both adapters.

Illustrative embodiments of the invention are explained in more detail with reference to drawings. The present invention is described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic perspective view of a longitudinal adjustment device for a vehicle seat, with an internally located adapter for the connection of different types of actuation assemblies;

FIG. 2A is a schematic side view showing a rail pair of a longitudinal adjustment device with an internally located adapter and rail lock;

FIG. 2B is a schematic plan view of a rail pair of a longitudinal adjustment device with an internally located adapter and rail lock;

FIG. 2C is a schematic partially sectional side view of a rail pair of a longitudinal adjustment device with an internally located adapter and rail lock;

FIG. 3A is a schematic plan view of one of various embodiments of an actuation assembly of a longitudinal adjustment device;

FIG. 3B is a schematic plan view of one of various embodiments of an actuation assembly of a longitudinal adjustment device;

FIG. 3C is a schematic plan view of one of various embodiments of an actuation assembly of a longitudinal adjustment device;

FIG. 3D is a schematic plan view of one of various embodiments of an actuation assembly of a longitudinal adjustment device;

FIG. 3E is a schematic plan view of one of various embodiments of an actuation assembly of a longitudinal adjustment device;

FIG. 4 is a schematic view of one of various embodiments of an adapter;

FIG. 5 is a schematic view of one of various embodiments of an adapter;

FIG. 6 is a schematic view of one of various embodiments of an adapter;

FIG. 7 is a schematic view of one of various embodiments of an adapter;

FIG. 8 is a schematic view of one of various embodiments of an adapter;

FIG. 9 is a schematic view of one of various embodiments of an adapter;

FIG. 10 is a schematic perspective view of an alternative embodiment of a longitudinal adjustment device with an alternative adapter;

FIG. 11 is a schematic partially sectional side view of the alternative embodiment of a longitudinal adjustment device with an alternative adapter;

FIG. 12 is a schematic perspective enlarged view of the alternative embodiment of a longitudinal adjustment device with an alternative adapter;

FIG. 13 is a schematic perspective enlarged view of the alternative embodiment of a longitudinal adjustment device in the rest position with an alternative adapter;

FIG. 14 is a schematic perspective enlarged view of the alternative embodiment of a longitudinal adjustment device in the rest position with an alternative adapter;

FIG. 15 is a schematic perspective enlarged view of the alternative embodiment of a longitudinal adjustment device with an alternative adapter, shown without actuation assembly;

FIG. 16 is a schematic plan view of the connection region of the adapter of FIG. 10;

FIG. 17 is a schematic sectional view through the connection region of FIG. 16 and through the rotation point of the adapter; and

FIG. 18 is a perspective view of the alternative adapter installed in the rail system.

### DESCRIPTION OF THE PREFERRED EMBODIMENTS

Referring to the drawings, parts corresponding to each other are provided with the same reference signs in all of the figures.

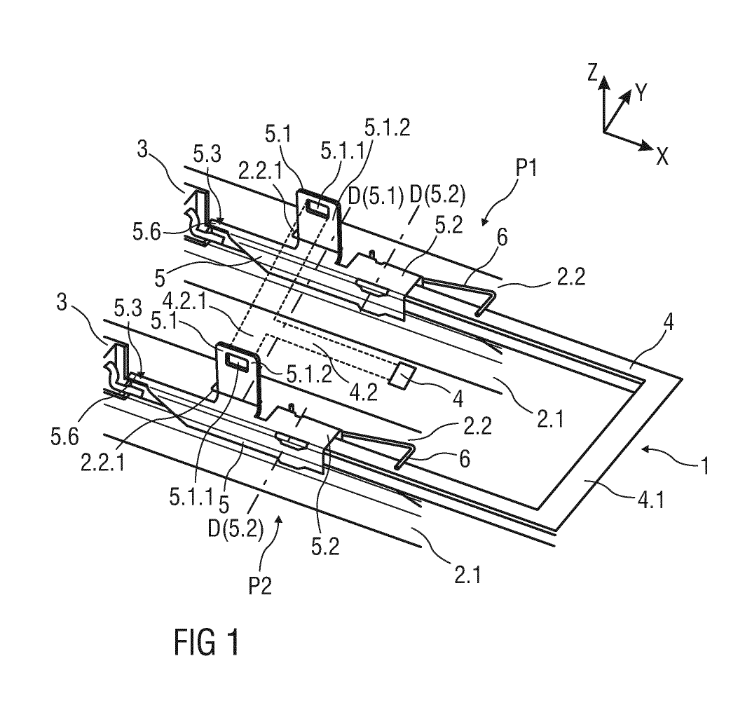

FIG. 1 shows a schematic perspective view of a longitudinal adjustment device 1 for a vehicle seat. The longitudinal adjustment device 1 serves for the manual length adjustment, i.e. the adjustment of a seat length position, of a vehicle seat (not shown in any detail). On each side of the vehicle seat, the longitudinal adjustment device 1 is provided with a respective rail pair P1, P2 of seat rails 2.1, 2.2, wherein one of the seat rails 2.1 of one of the rail pairs P1, P2 is respectively secured to the vehicle and connected to a vehicle structure, in particular to the vehicle floor. The other seat rail 2.2 is secured to the vehicle seat.

The two seat rails 2.1, 2.2 mutually engage to form a rail profile and are movable relative to each other in the longitudinal direction, wherein balls (not shown) are arranged between the two seat rails 2.1, 2.2 in order to reduce the friction.

Generally, the longitudinal adjustment device 1 according to the invention preferably has two rail pairs P1, P2, each with an upper rail and a lower rail as seat rails 2.1, 2.2.

The two seat rails 2.1, 2.2 are lockable to each other by means of a rail lock 3. The rail lock 3 is arranged substantially inside the rail profile and can be configured in any desired way, for example as a latching plate or a latching lever or a latching pawl.

This rail lock 3 is releasable and actuatable by means of at least one actuation assembly 4, which is arranged at least partially outside the seat rails 2.1, 2.2. The actuation assembly 4 for actuating, in particular unlocking or releasing, the rail lock 3 can be configured in various ways, for example as a yoke 4.1 or a hand grip 4.2. The actuation assembly 4 is configured in such a way that it protrudes at the front end of the vehicle seat and can be actuated by a user.

The rail lock 3 is in particular configured separately and has at least one locking element 3.1, which is arranged movably on one of the seat rails 2.1, 2.2, in particular on the upper seat rail 2.2, and is optionally pretensioned and, in the locked state, engages, in a locking manner, in both seat rails 2.1, 2.2, for example by means of teeth (not shown), for example in slit-shaped rail openings (not shown).

At least one adapter 5 is arranged between the actuation assembly 4 and the rail lock 3, which adapter 5 is configured as a force transmission element and, for the purpose of connecting the actuation assembly 4, comprises at least one integrated connection region 5.1, which protrudes from the rail profile, and, for the purpose of unlocking the separate rail lock 3, comprises at least one integrated unlocking element 5.6, which protrudes from the adapter 5 in the direction of the rail lock 3.

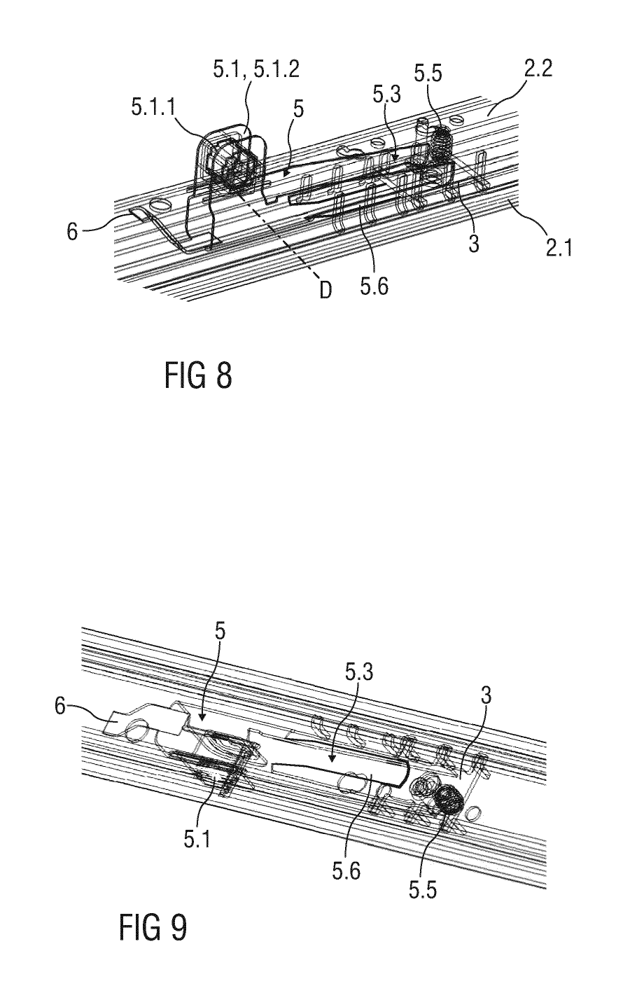

Optionally, as is shown in FIGS. 1 to 9, the adapter 5 configured as a force transmission element can be configured in such a way that at least two differently configured actuation assemblies 4, such as a yoke 4.1 or a hand grip 4.2, can be secured releasably on the adapter 5.

For each longitudinal adjustment device 1 and each rail pair P1, P2, an adapter 5 is provided which interacts in each case with an associated rail lock 3, wherein a common actuation assembly 4 interacts via, and with, the two adapters 5 with the two rail locks 3. One adapter 5 is arranged per rail pair P1, P2.

The adapter 5 is in each case arranged internally in the rail profile and protrudes at least in parts from the rail profile and is designed and configured for the connection of different types of actuation assemblies 4.

The adapter 5 has at least two connection regions 5.1, 5.2 which are each configured corresponding to one of the differently configured actuation assemblies 4. A modular adapter 5 configured in this way permits simple adaptation and integration of differently configured actuation assemblies 4 on one longitudinal adjustment device 1. The adapter 5 can in this case have a one-part or multi-part design.

In order to receive and retain an actuation assembly 4 arranged externally on the rail profile, one of the connection regions 5.1 in this case protrudes from the rail profile perpendicularly with respect to the longitudinal orientation of the seat rails 2.1, 2.2 and is configured as a continuation, retaining lug or retaining tab. For this purpose, for example, the upper seat rail 2.2 is provided with a recess 2.2.1, wherein at least one connection arm 5.1.2 in the form of a retaining tab or retaining lug issues perpendicularly from the adapter 5, in particular from the profile as base element, in the connection region 5.1, on which the actuation assembly 4 engaging from the outside can be fixed with form-fit and/or force-fit engagement.

This outer connection region 5.1 lying outside the rail profile has an opening 5.1.1 in which one of the actuation assemblies 4, in particular the hand grip 4.2, can be received from the outside and can be fixed with form-fit and/or force-fit engagement, for example by clipping or latching.

Another connection region 5.2 is arranged inside the rail profile formed by the seat rails 2.1, 2.2 and thus forms an inner connection region 5.2 of the adapter 5.

This inner connection region 5.2 extends in the longitudinal orientation of the seat rails 2.1, 2.2 inside the rail profile. Here, for example, an actuation assembly 4, configured as a yoke 4.1 for example, is inserted from the front into the rail profile onward into the inner connection region 5.2 of the respective adapter 5 and is there connected to the adapter 5.

The adapter 5, on the side facing toward the actuation assembly 4, is connected to the latter with form-fit and/or force-fit engagement. For this purpose, the adapter 5 is configured as a partially open, for example U-shaped, or closed profile. In the illustrative embodiment according to FIG. 1, the adapter 5 has a U-shaped profile in the area of the inner connection region 5.2, such that an actuation assembly 4 inserted from the front into the rail profile can be easily and securely inserted into and fixed in the internally located adapter 5.

As an alternative to the U-shaped profile of the adapter 5 in the inner connection region 5.2, the latter can also be configured as a C-shaped or L-shaped profile or a combination of different profiles.

To avoid rattling noises and to automatically retain the actuation assembly 4 in the passive position or rest position, the latter is held with spring pre-tensioning on the adapter 5. For this purpose, a spring element 6, for example a leg spring, is arranged between the actuation assembly 4 and the respective connection region 5.1 or 5.2.

On the other side of the adapter 5 lying opposite the actuation assembly 4, in the direction of the rail lock 3, the adapter 5, in particular the adapter end 5.3 thereof, is configured in such a way that, upon actuation of the respectively connected actuation assembly 4, i.e. hand grip 4.2 or yoke 4.1, it engages with the separate rail lock 3 in order to unlock same. In particular, on account of the actuation of the actuation assembly 4, there is a pivoting of the adapter 5 and therefore of the adapter end 5.3, as a result of which the latter engages in the separate rail lock 3 in such a way that it is brought vertically downward into an unlocked position.

In the unactuated position of the actuation assembly 4, the lock-side adapter end 5.3 in question is arranged at a distance from the separately configured rail lock 3. For this purpose, the adapter end 5.3 has a lug-like continuation, which forms the integrated unlocking element 5.6.

For example, the unlocking element 5.6 engaging on the rail lock 3 is configured as an unlocking lever or an unlocking arm which, when the actuation assembly 4 is actuated, acts on the rail lock 3, in particular pressing the latter vertically downward and unlocking it. Thus, the adapter 5 can be used for different types of rail locks 3 and can also be integrated in already existing longitudinal adjustment device 1. An additional unlocking lever of a conventional type can be omitted.

As is shown, for reasons of symmetry, two adapters 5 are arranged, one in the right-hand rail pair P1 and one in the left-hand rail pair P2, wherein the two adapters 5 are connected to each other via the actuation assembly 4. The hand grip 4.2 is here provided with a transverse rod or a transverse bar 4.2.1, the ends of which are retained in the openings 5.1.1 with form-fit and/or force-fit engagement.

In a manner not shown in detail, the above-described modular adapter 5 with the different connection regions 5.1, 5.2 can have a one-part or multi-part design. Thus, the profile, in particular the connection region 5.2, can be made of metal, and the at least one connection arm 5.1.2 can be made of plastic. Alternatively, the adapter 5 can be configured as a one-part plastic or metal component.

Moreover, the adapter 5 is configured as a force transmission element in such a way that the rotation point D of the actuation assembly 4 is formed in the area of the seat-side seat rail 2.2. Thus, the rotation point D of the actuation assembly 4 is offset inwardly from the latter toward the adapter 5. For this purpose, the adapter 5 is mounted pivotably on the seat-side seat rail 2.2.

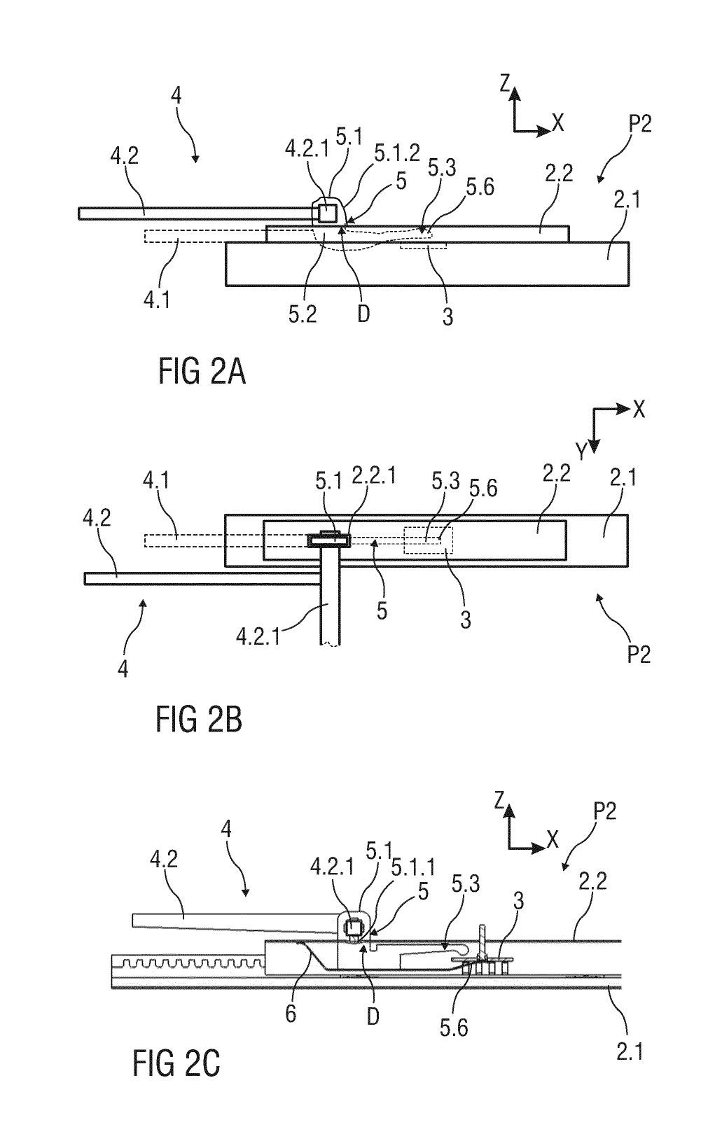

FIGS. 2A, 2B and 2C are schematic depictions, in side view and plan view, of a rail pair P2 of a longitudinal adjustment device 1 according to the invention with an internally located adapter 5 and with an internally located rail lock 3. The adapter 5 is configured as a force transmission element in such a way that, for the purpose of connecting an actuation assembly 4, at least one connection region 5.1 protrudes from the rail profile, and, for the purpose of unlocking the rail lock 3, at least one integrated unlocking element 5.6 is provided.

The adapter 5 is suitable and configured for receiving, via the outer connection region 5.1, the externally engaging actuation assembly 4 in the form of the hand grip 4.2 and for interacting therewith in order to unlock the inner rail lock 3.

The integrated connection region 5.1 of the adapter 5 protrudes perpendicularly from the slit-shaped recess 2.2.1 in the upper seat rail 2.2. The actuation assembly 4 is secured on this protruding outer connection region 5.1 for conjoint rotation therewith, such that a pivoting of the actuation assembly 4 on the hand grip 4.2, in particular in a small pivot range of 5° to 15° leads to a pivoting of the connection region 5.1, as a result of which the rotation point D of the actuation assembly 4 is formed in the connection region 5.1, in particular in the edge area of the seat-side seat rail 2.2. For this purpose, at least the connection region 5.1 of the adapter 5 is formed from a spring steel sheet.

Optionally, an inner connection region 5.2 can be formed on the adapter 5 and is suitable and configured to receive the internally engaging actuation assembly 4 in the form of a yoke 4.1 and to interact therewith in order to unlock the inner rail lock 3.

During operation, only one of the actuation assemblies 4 (either the hand grip 4.2 or the yoke 4.1) is arranged on the longitudinal adjustment device 1 and is in engagement and interacts with the adapter 5.

For the automatic resetting and retention of the rail lock 3 in the operating or blocking position for blocking the two seat rails 2.1, 2.2, said rail lock 3 is pretensioned by a spring. For this purpose the integrated unlocking element 5.6 is configured as a restoring spring. In other words, the integrated unlocking element 5.6 at the adapter end 5.3 is configured as a spring arm which issues from the profile of the adapter 5 and actively engages on the rail lock 3 and here serves as locking spring and restoring spring. The unlocking element 5.6 can be configured in such a way that a torsional force acts on the rail lock 3 from above and presses the latter into the unlocked position.

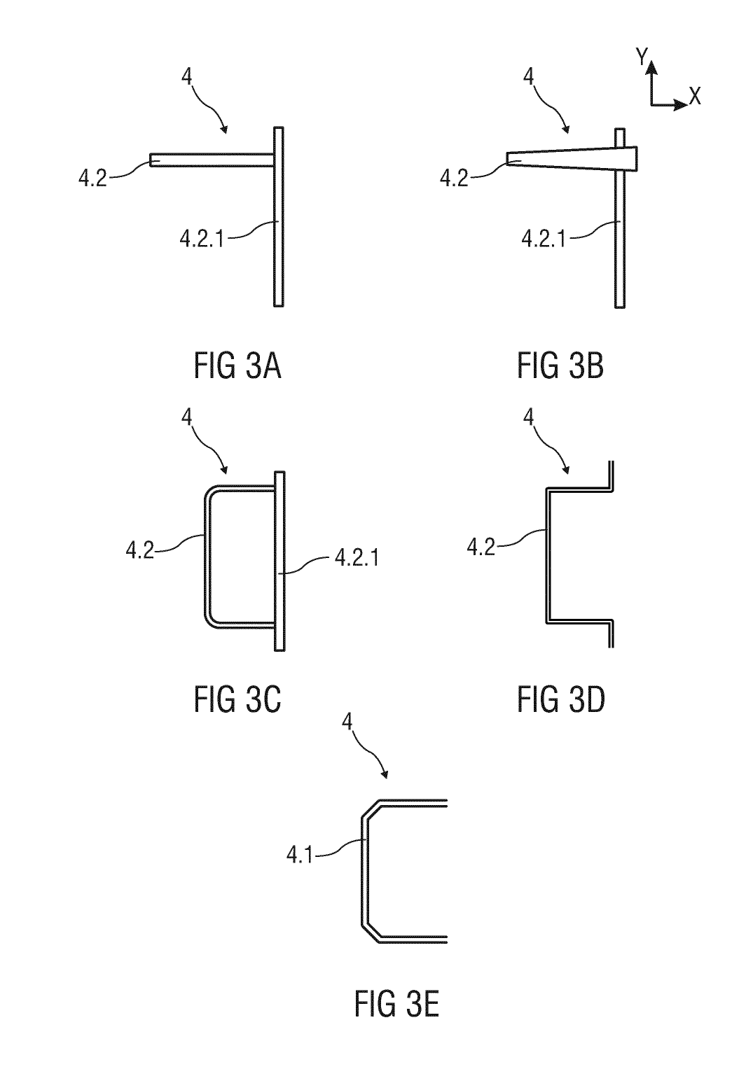

FIGS. 3A to 3E show schematic plan views of various embodiments of an actuation assembly 4 of the longitudinal adjustment device 1. Here, the actuation assembly 4 can be configured as an operating lever engaging externally on the adapter 5 with a transverse rod 4.2.1 with a welded-on hand grip 4.2 (FIG. 3A) made of metal, or a mechanically connected hand grip 4.2 (FIG. 3B) made of plastic, or a transverse rod 4.2.1 with a welded-on yoke as hand grip 4.2 (FIG. 3C), in particular a U-shaped yoke, or as one-part transverse yoke as hand grip 4.2 (FIG. 3D) made of plastic or metal.

Alternatively, the actuation assembly 4 can be configured as an operating yoke engaging from the inside in the rail profile and the internally located adapter 5 and having a yoke 4.1, in particular a U-shaped yoke, made of plastic or metal or as a hybrid component.

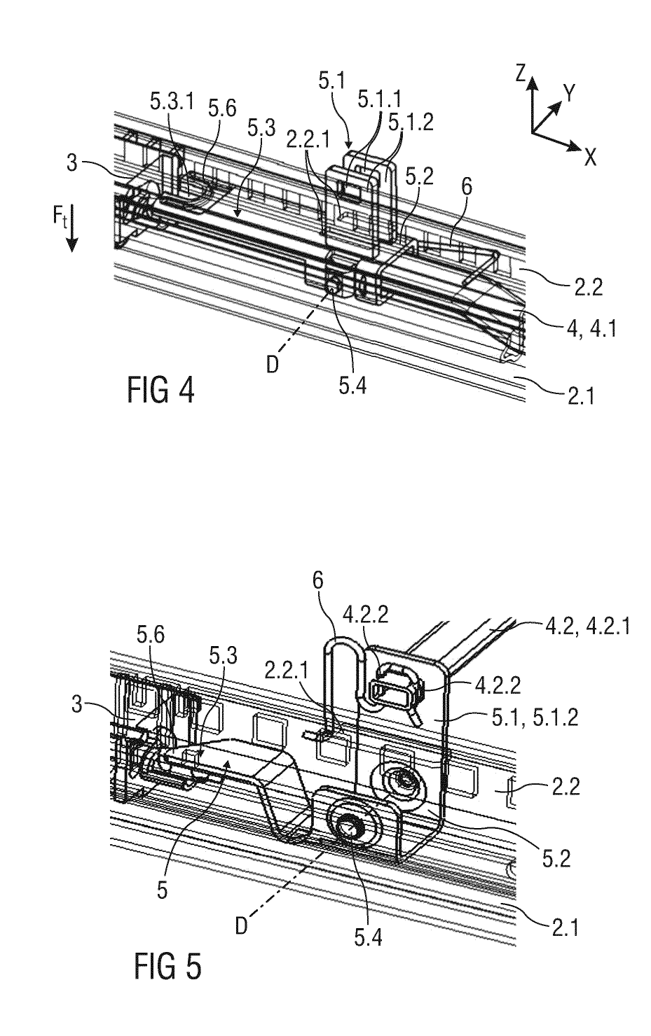

FIGS. 4 to 9 show schematic views of various embodiments of an adapter 5 according to the invention for a longitudinal adjustment device 1 for connection of differently configured actuation assemblies 4.

The adapter 5 is configured in such a way that it can be mounted and integrated in already existing longitudinal adjustment device 1. The adapter 5 is in this case configured as a force transmission element, which is configured in such a way that at least two differently configured actuation assemblies 4 can be secured releasably on the adapter 5. For this purpose, the respectively shown adapter 5 has at least two connection regions 5.1, 5.2, which are each configured in a manner corresponding to one of the differently configured actuation assemblies 4, wherein the adapter 5 can be of a modular construction and can be in one or more parts. Alternatively, the adapter 5 can also have only one connection region 5.1 or 5.2.

FIG. 4 shows an adapter 5 with a closed hollow profile in the connection region 5.2 for receiving an internally engaging actuation assembly 4, such as a yoke 4.1, and a connection region 5.1 which protrudes perpendicularly therefrom and which is formed by two connection arms 5.1.2 arranged in parallel for receiving an externally engaging actuation assembly 4, such as a hand grip 4.2. Alternatively, it is also possible for just one connection arm 5.1.2 to be provided (FIG. 5).

The adapter 5 has substantially in the connection region 5.2 a closed hollow profile in which an internally engaging actuation assembly 4, such as a yoke 4.1, actively engages as described above. The adapter 5 extends substantially rectilinearly in the longitudinal orientation with a surface side, in particular the surface side facing in the direction of the upper seat rail 2.2. The connection arms 5.1.2 can be configured in one piece with the hollow profile. Alternatively, these can be made separately and from plastic and can be arranged with force-fit and/or form-fit engagement, and/or by a material bond, in recesses of the hollow profile.

The end 5.3 facing toward the rail lock 3 and the integrated unlocking element 5.6 engaging actively therein is configured as an I-shaped profile and, as is shown, can be provided with a recess 5.3.1 which serves to generate an interface to the rail lock 3. The unlocking element 5.6 is in this case configured as a torsion spring such that, upon rotation of the adapter 5, a torsional force Ft acts on the rail lock 3 and presses the latter into the unlocked position.

The spring element 6, for example a yoke spring or leg spring, is held in the connection region 5.2 and is arranged at the opposite end on the actuation assembly 4 and pretensions the latter in the rest position or passive position, such that rattling is prevented.

FIG. 5 shows an alternative embodiment for an adapter 5 with only one connection arm 5.1.2 in the connection region 5.1 for receiving the externally engaging actuation assembly 4, which is likewise held with pretensioning by means of a spring element 6, in particular a yoke spring or leg spring. In this case, the transverse bar 4.2.1 is pushed fully through the opening 5.1.1 and, at the free end protruding from the opening 5.1.1, has a groove 4.2.2 in which the spring element 6 engages, such that the transverse bar 4.2.1 is held and pretensioned. The rail-side spring end of the spring element 6 is held in the recess 2.2.1 of the seat rail 2.2.

In the connection region 5.2 for the internally engaging actuation assembly 4, the adapter 5 has a C-shaped profile. For the active engagement of the adapter end 5.3 with the integrated unlocking element 5.6, the adapter 5 runs in an arc shape in the longitudinal extent, particularly in an S shape, wherein the base of the C-shaped profile is lower than the adapter end 5.3. In this illustrative embodiment, the rotation point D of the actuation assembly 4 lies in the area of the adapter 5 and there in particular in the area of the upper seat rail 2.2. For this purpose, the adapter 5 is mounted rotatably in this area of the seat rail 2.2 by means of bearing journals 5.4.

The adapter 5 shown in FIG. 5 serves in particular for the connection of an externally engaging actuation assembly 4.

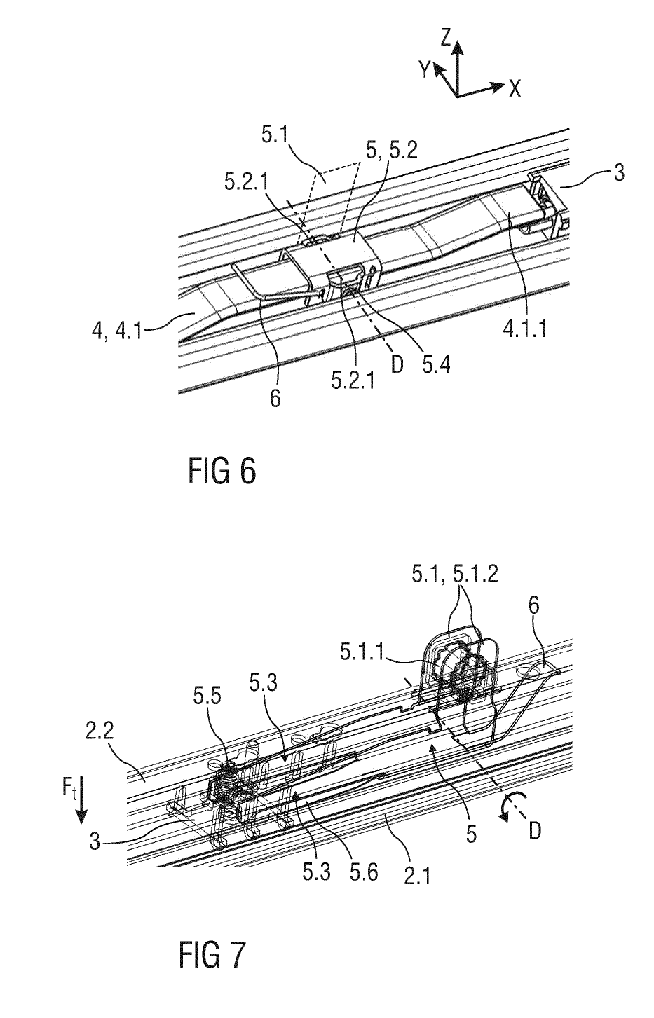

FIG. 6, in which the connection region 5.1 has been omitted, shows an example of the rotatable bearing of the adapter 5 in the upper seat rail 2.2 in the form of a bearing journal 5.4. In this illustrative embodiment, the modular adapter 5 does not have the adapter end 5.3, engaging optionally in the rail lock 3, with integrated unlocking element 5.6. The adapter 4 is thus of a compact configuration in which the yoke ends 4.1.1 of the internally engaging actuation assembly 4 are lengthened and are accordingly bent several times and guided through the adapter 5 and engage actively on the rail lock 3.

Furthermore, the connection region 5.2 of the adapter 5 has slit-shaped openings 5.2.1 in which separate connection arms 5.1.2 of the connection region 5.1 can be arranged, in particular plugged in and/or latched.

The adapter 5 shown in FIG. 6 serves in particular for the connection of an internally engaging actuation assembly 4.

FIGS. 7 to 9 show an alternative embodiment of an adapter 5 according to the invention in a one-part form with an integrated outer connection region 5.1 protruding from the rail profile and with an integrated, in particular integrally molded, spring element 6 for pretensioning the externally engaging actuation assembly 4, such that the latter is reset again to its starting position (as shown) after actuation, and with an integrated, in particular integrally molded, unlocking element 5.6 at the adapter end 5.3 for unlocking/opening the rail lock 3.

The spring element 6 is in this case configured as a spring arm protruding from the profile of the adapter 5.

The integrated unlocking element 5.6 at the adapter end 5.3 is likewise configured as a spring arm protruding from the profile of the adapter 5, in particular as a torsion spring arm which actively engages in the rail lock 3 and here serves as locking spring and restoring spring. When the actuation assembly 4 is actuated in this case, the adapter 5 is pivoted and, consequently, the unlocking element 5.6 is rotated and the spring tensioned when acting on the rail lock 3, such that a torsional force Ft acts on the rail lock 3.

In this way, no further spring is needed for the rail lock 3. For guiding the rail lock 3, the latter is held and guided by means of a guide pin 5.5 on the adapter 5. The adapter end 5.3 configured as a spring arm is shown somewhat overlapped in the view (spring pretensioning).

The adapter 5 according to the invention has a simple structure and allows various types of actuation assemblies 4 to be arranged on a longitudinal adjustment device 1 and can be retrofitted on already existing longitudinal adjustment device 1. A novel longitudinal adjustment device 1 according to the invention with the adapter 5 according to the invention is universally usable and permits both a use with internal actuation, in particular with an internally engaging operating yoke, and also with external actuation, in particular with an externally engaging operating lever. Moreover, a longitudinal adjustment device of this configuration is suitable for rail arrangements both with a high and also a low rail profile. Moreover, a longitudinal adjustment device of this kind is independent of the nature and configuration of the rail lock and is thus suitable for adaptation of any kind of rail lock.

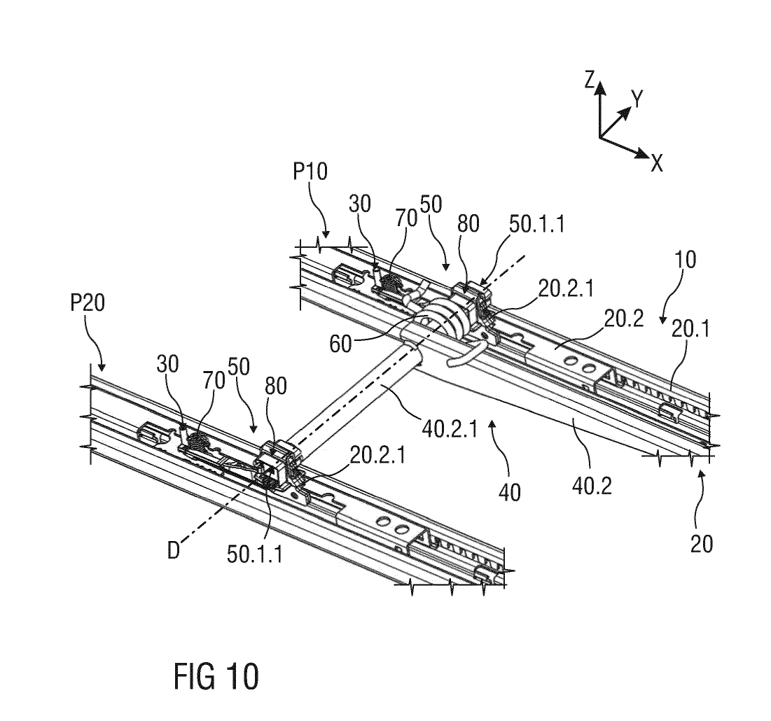

FIGS. 10 to 18 show schematic views of an alternative embodiment of a longitudinal adjustment device 10 with an adapter 50 and an actuation assembly 40. The adapter 50 is made of a metal, for example steel. Alternatively, the adapter 50 can be made of another suitable hard material. For example, the adapter 50 can be made of a fiber-reinforced plastic or as a hybrid component, in particular a metal/plastic component.

On each side of the vehicle seat, the longitudinal adjustment device 10 is provided with a rail system 20 comprising two rail pairs P10, P20, each with two seat rails 20.1, 20.2.

In this case, one of the rails 20.1 of one of the rail pairs P1, P2 is respectively made secure with the vehicle and connected to a vehicle structure, in particular the vehicle floor. The other seat rail 20.2 is secured to the vehicle seat.

The two seat rails 20.1, 20.2 mutually engage to form a rail profile and are movable relative to each other in the longitudinal direction.

The two seat rails 20.1, 20.2 of a rail pair P10 or P20 are lockable to each other by means of a rail lock 30. The rail lock 30 is arranged inside the rail profile and is configured, for example, as a latch plate.

The rail lock 30 is pretensioned in the unlocked position by means of a spring 70. The spring 70 is configured as a restoring spring which resets the rail lock 30 automatically from the unlocked position to the locked position.

This rail lock 30 is releasable and actuatable by means of the actuation assembly 40, which is arranged at least partially outside the seat rails 20.1, 20.2. The actuation assembly 40 comprises an actuation arm 40.2 as hand grip, for example.

A release mechanism is arranged between the actuation arm 40.2 and the rail lock 30 and couples these to each other in such a way that, when the actuation arm 40.2 is actuated, the rail lock 30 is released and unlocked such that one of the seat rails 20.1, 20.2 can be moved relative to the other one.

The release mechanism comprises the lever-shaped adapter 50 with a connection region 50.1 for a transverse bar 40.2.1 of the actuation arm 40.2, which connection region 50.1 protrudes from the rail profile, in particular from the upper seat rail 20.2. The connection region 50.1 is configured in such a way that the externally engaging actuation arm 40.2, in particular the transverse bar 40.2.1 thereof, can be fixed thereon with form-fit and/or force-fit engagement. For example, the transverse bar 40.2.1 can be arranged with a clipping or latching action in an opening 50.1.1 in the connection region 50.1.

The upper seat rail 20.2 has no openings in the side walls for releasing the rail lock 30. This increases the rail strength.

The connection region 50.1 and the adapter 50 are provided with the rail lock 30 in order to couple the actuation arm 40.2, such that a conventional additional unlocking lever for the rail lock 30 can be omitted.

In order to unlock both rail pairs P10 and P20, and for reasons of symmetry, two adapters 50 configured as release levers are provided which are connected to each other by means of the common actuation arm 40.2. In this case, the actuation arm 40.2 is provided with the transverse bar 40.2.1, of which the ends are held with form-fit and/or force-fit engagement in the openings 50.1.1. The transverse bar 40.2.1 in this case has, at least in the area of the free ends, a cross-sectional shape deviating from a round cross section. In particular, at the ends the transverse bar 40.2.1 has a profiled cross section or rectangular cross section, which permits an improved transmission of force and an improved fastening on the connection region 50.1 of the adapter 50.

The internal release mechanism and the internal rail lock 30 minimize accidental release. Moreover, a common external actuation arm 40.2 can be used for both adapters 50 and both rail locks 30.

The respective adapter 50 is formed in one piece from metal or plastic or as a hybrid component of metal and plastic, wherein the connection region 50.1 is made of metal and the adapter end 50.3 is made of plastic.

The respective adapter 50 forms a force transmission element for transmitting and transforming the rotation of the actuation arm 40.2 into a vertical movement of the rail lock 30 for the purpose of unlocking the latter. The adapter 50 and the connection of the actuation arm 40.2 are configured in such a way that the rotation point D of the actuation arm 40.2 is formed in the area of the upper seat rail 20.2, in particular in the edge area of the upper seat rail 20.2. Thus, the rotation point D of the actuation arm 40.2 is offset inwardly from this toward the adapter 50. For this purpose, the adapter 50 is mounted pivotably on the upper seat rail 20.2.

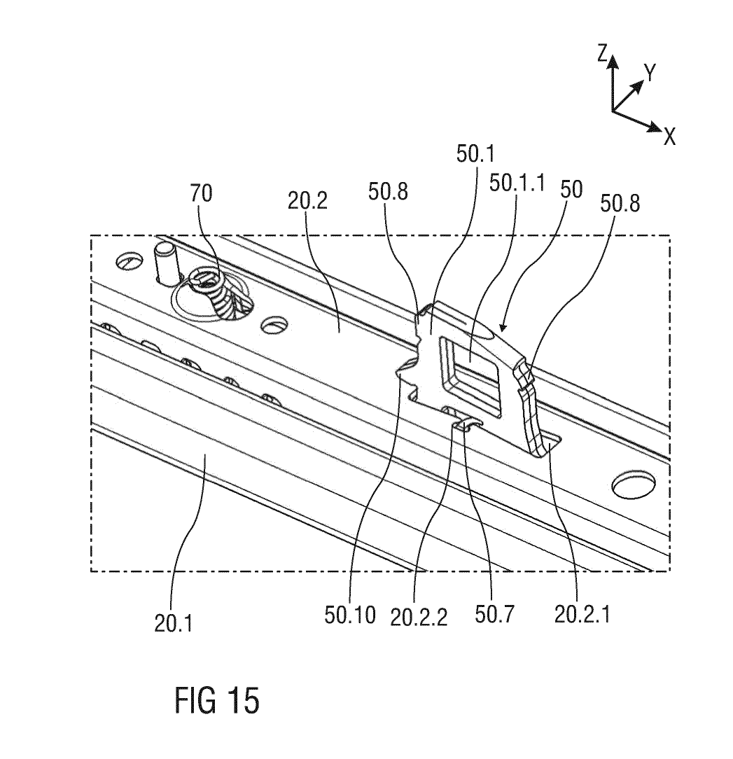

The upper seat rail 20.2 has at least one slit-shaped recess 20.2.1 through which the connection region 50.1 of the adapter 50 is guided. The upper seat rail 20.2 comprises, in the upper base area, further recesses or openings for receiving the spring 70 and the plate pin, as shown in FIG. 15.

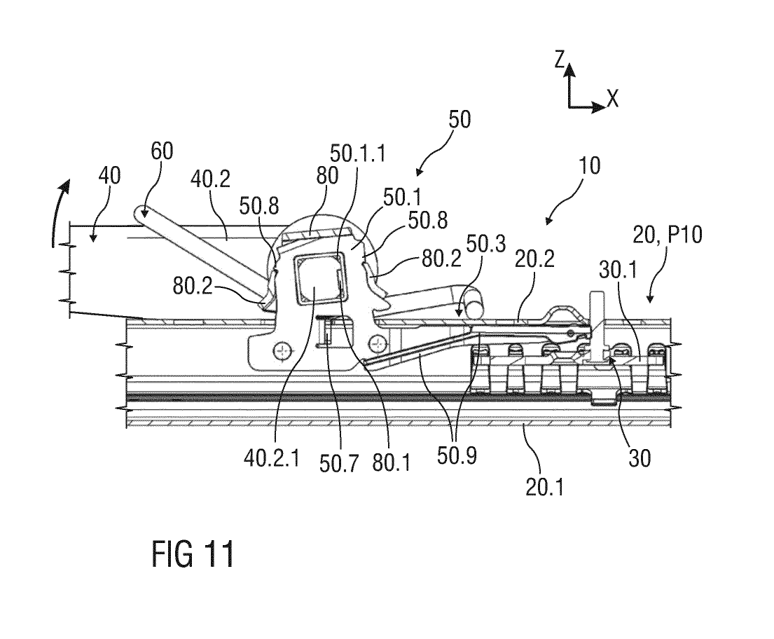

FIG. 11 shows a schematic view, in longitudinal section, of the longitudinal adjustment device 10 with the rail lock 30 and the actuation assembly 40 which, by way of the adapter 50, acts on the rail lock 30 in order to unlock the latter.

The rail lock 30 comprises a latch plate configured as a locking element 30.1. The latch plate is provided laterally with latching teeth which engage in latch openings of the seat rails 20.1, 20.2 and are vertically movable there between an unlocked position and a locked position.

To avoid rattling noises and to permit automatic retention of the actuation arm 40.2 in the passive position or rest position, said actuation arm 40.2 is held with spring pretensioning on the rail system 20, in particular on one of the rail pairs P10. For this purpose, a spring element 60, for example a yoke spring, a leg spring or helical spring, is arranged between the actuation arm 40.2 and the upper seat rail 20.2. When the actuation arm 40.2 is actuated, in particular pivoted, it rotates upward, as a result of which the transverse bar 40.2.1 is rotated, and the adapter 50 is in turn rotated by the latter and the spring element 60 further tensioned.

The respective connection region 5.1 of the adapter 50 protruding from the recess 20.2.1 is provided with a cover 80. The respective cover 80 is configured in such a way that it holds the associated connection region 50.1 of the adapter 50 with form-fit and/or force-fit engagement, such that the adapter 50 is held during the mounting of the transverse bar 40.2.1 on the upper seat rail 20.2. In addition, the respective cover 80 is configured in such a way that it forms a limit stop for the transverse bar 40.2, such that this is fixed between both rail pairs P10 and P20.

The cover 80 has a limit stop 80.1 for the end of the transverse bar 40.2.1 protruding into the cover 80. The limit stop 80.1 is configured, for example, in the form of an abutment surface or a protruding hook.

In addition, the cover 80 has a retention element 80.2 for retaining the connection region 50.1 of the adapter 50 inserted into the cover 80, in particular into an adapter slit. The retention element 80.2 is configured, for example, as a clip or latching hook or an abutment surface for hook-shaped protuberances 50.8 on the edge of the connection region 50.1.

The rail lock 30 comprises an individual plate-shaped locking element 30.1. At the adapter end 50.3, the adapter 50 comprises a damping element 50.9 which, for example, is clipped, plugged or latched, or secured by means of an elastic band, on the adapter end 50.3. The damping element 50.9 is made from a soft plastic material and is configured to actuate various rail locks 30. The damping element 50.9 serves to provide freedom from rattling.

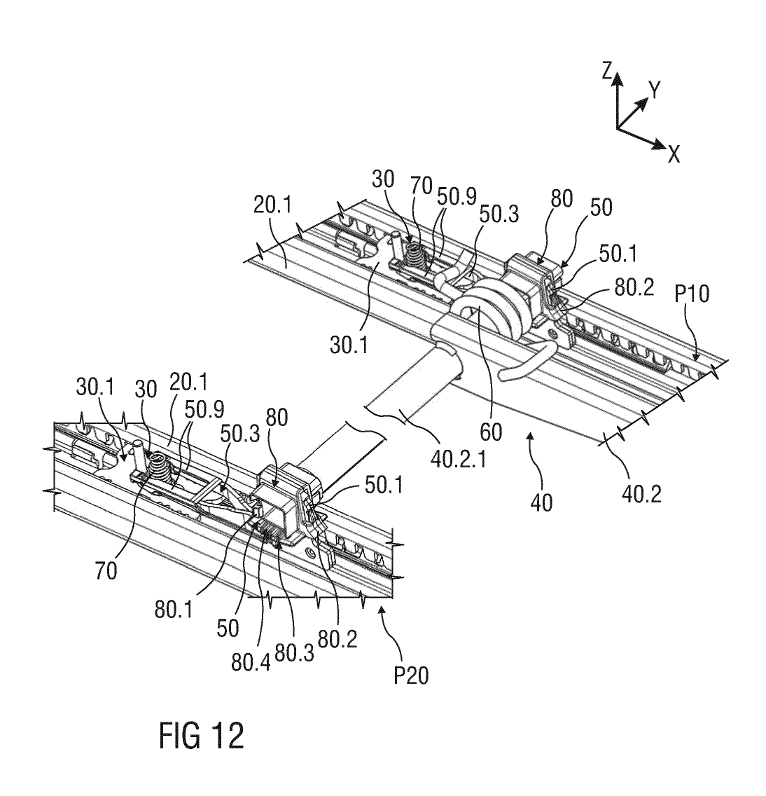

As is shown in FIG. 12, the cover 80 is formed flexibly in the contact region 80.3 facing toward the upper seat rail 20.2, in order to compensate for forces acting in the Z direction. For this purpose, the contact region 80.3 is shaped accordingly, for example curved in the Z direction and inclined in the Y direction and provided with a number of support ribs 80.4. The support ribs 80.4 can in this case be made of a flexible material. In particular, the cover 80 is made of plastic.

FIG. 12 shows a schematic perspective view of the actuation assembly 40 and the rail pairs P10 or P20 without upper seat rail 20.2, such that the rail lock 30 and the coupling of the adapter 50 to the rail lock 30 and the actuation assembly 40 are visible.

The respective adapter 50 comprises the connection region 50.1 with the opening 50.1.1 for receiving one of the ends of the transverse bar 40.2.1 and the internal adapter end 50.3, which has a fork-shaped design, for example, and, during movement into and in the unlocked position, engages actively from above in the rail lock 30, in particular on the locking element 30.1.

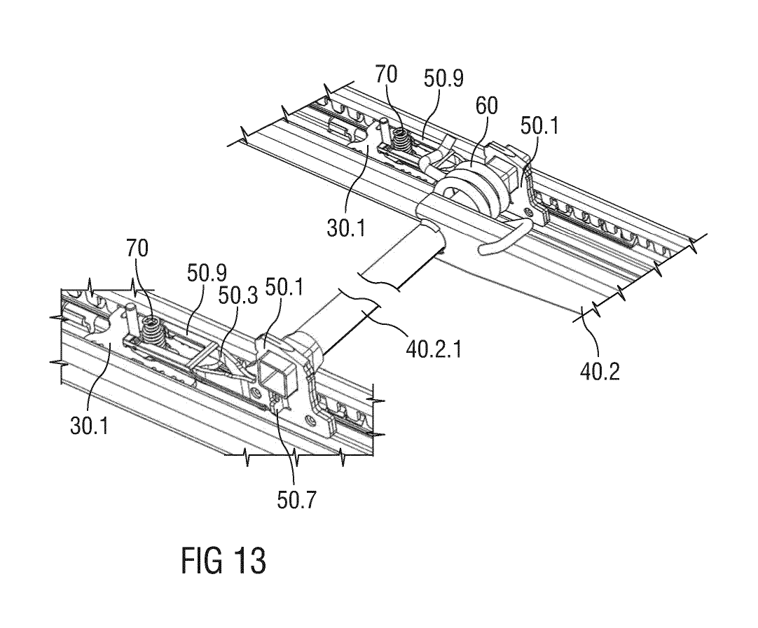

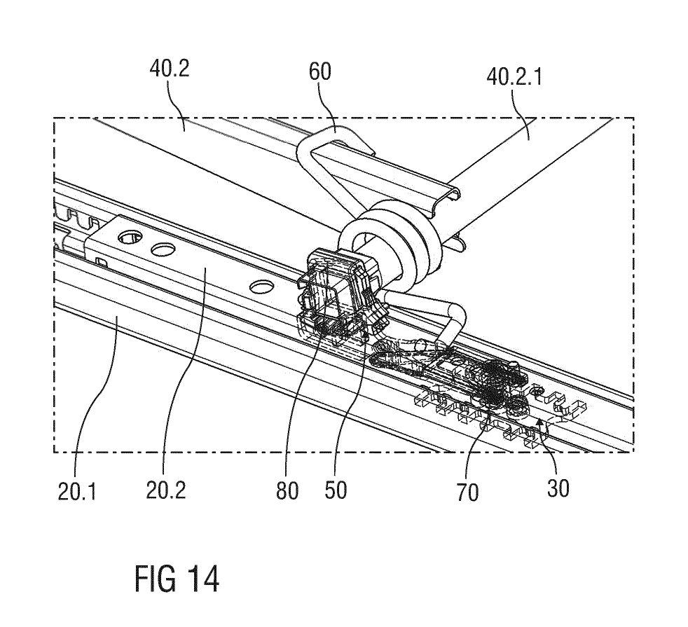

FIGS. 13 and 14 show the actuation assembly 40 in each case in the rest position, hence the unactuated position, and thus show the rail lock 30 in the locked position, in which both seat rails 20.1, 20.2 are locked onto each other.

FIG. 15 shows a perspective view of one of the rail pairs P20 without actuation assembly 40. To secure the adapter 50 against a displacement in the longitudinal direction (X direction), the connection region 50.1 has two retaining lugs 50.7 which protrude transversely with respect to the X direction and which are arranged in corresponding protuberances 20.2.2 in the upper seat rail 20.2.

In addition, the adapter 50 has an abutment 50.10 as limit stop in the Z direction, in order in particular to protect the plastic components. In the assembled state, the abutment 50.10 lies on the upper seat rail 20.2.

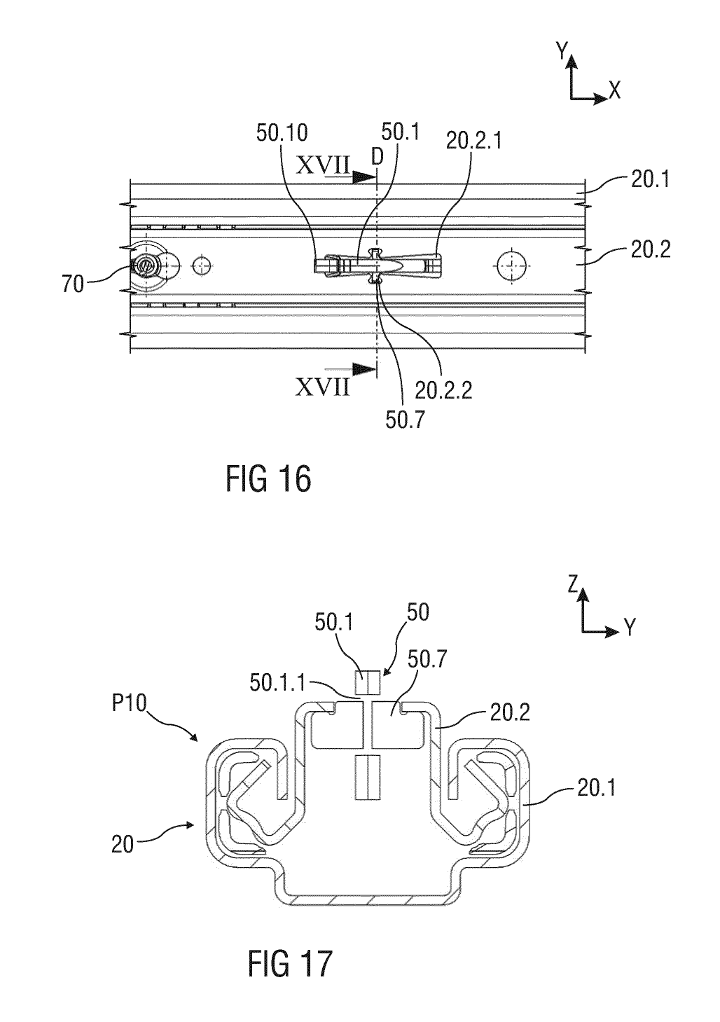

FIG. 16 shows a schematic plan view of the connection region 50.1 of the adapter 50 arranged in the slit-shaped recess 20.2.1.

The slit-shaped recess 20.2.1 and the protuberances 20.2.2 are configured in such a way that they support the adapter 50 in the X direction and Y direction. In particular, the recess 20.2.1 is configured widening toward the respective end, that is to say the recess 20.2.1 has an increasing width toward its ends. The protuberances 20.2.2 protruding from the recess 20.2.1 are likewise configured widening in the outward direction.

FIG. 17 shows the section through FIG. 16 and through the rotation point D of the adapter 50.

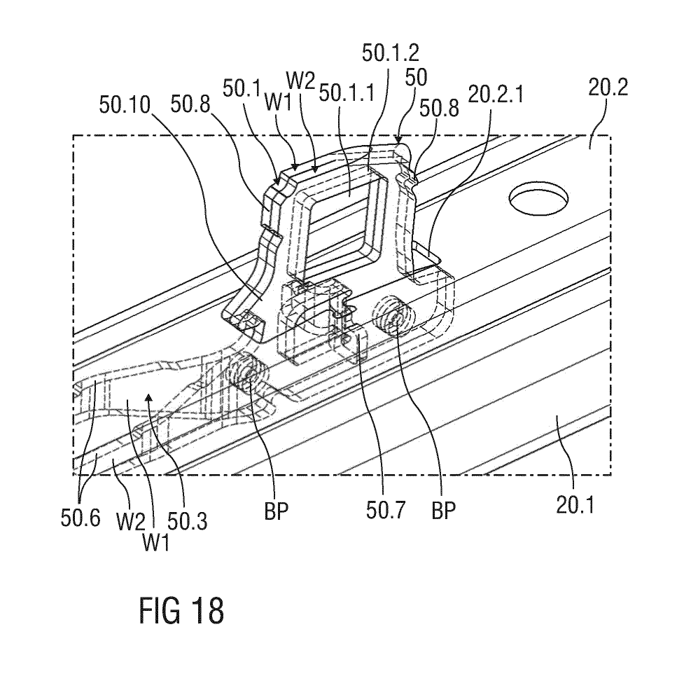

FIG. 18 shows a perspective view of the adapter 50 installed in the rail system 20.

The adapter 50 has a multi-part structure, in particular formed from two wall parts or walls W1, W2. The adapter 50 is made of a metal, for example steel. Alternatively, the adapter 50 can be made of a harder material, in particular a hard plastic, or can be configured as a two-component structure, in particular as an injection-molded part composed of metal encapsulated by plastic.

In a further embodiment, provision is made that the adapter 50 is configured as a double-walled shaped part. In this case, the adapter 50 is formed from a single shaped part which has a mirror-symmetrical design and is folded along an axis of symmetry, as a result of which the two walls W1, W2 bearing on each other in the connection region 50.1 are formed. The two walls W1, W2 bearing on each other in the connection region 50.1 form the connection arm 50.1.2 for the actuation assembly 40.

The walls W1, W2 are at a distance from each other in the area of the adapter end 50.3. For this purpose, the walls W1, W2 are widened and form two protruding arms, which form the integrated unlocking element 50.6 that then engages on the rail lock 30.

Alternatively, the adapter 50 can be formed from two identical shaped parts or walls which are connected to each other at fastening points BP.

Moreover, in the connection region 50.1, the two tab-shaped retaining lugs 50.7 protrude away from each other and outward from the walls W1, W2 bearing on each other.

While specific embodiments of the invention have been shown and described in detail to illustrate the application of the principles of the invention, it will be understood that the invention may be embodied otherwise without departing from such principles.

1. A longitudinal adjustment device of a vehicle seat, the longitudinal adjustment device comprising:
at least one vehicle secured seat rail secured to the vehicle;
at least one seat secured seat rail secured to the seat, the at least one vehicle secured seat rail and the at least one seat secured seat rail being configured to mutually engage to form a rail profile and to move relative to each other in a longitudinal direction;
at least one rail lock with which the seat rails are lockable to each other;
at least one actuation assembly for actuating the rail lock
at least one adapter is arranged between the actuation assembly and the rail lock, said adapter being configured as a force transmission element such that at least one connection region of the adapter protrudes from the rail profile to connect the actuation assembly; and
at least one integrated unlocking element is provided on the adapter to unlock the rail lock, said unlocking element being configured to actively engage in the rail lock to unlock same, upon actuation of the actuation assembly.

2. The longitudinal adjustment device as claimed in claim 1, wherein the adapter is arranged inside the rail profile formed by the seat rails and protrudes at least in parts from the rail profile.

3. The longitudinal adjustment device as claimed in claim 1, wherein the adapter has at least two connection regions, which are each configured corresponding to one of differently configured actuation assemblies.

4. The longitudinal device as claimed in claim 1, wherein an inner connection region of the adapter is arranged inside the rail profile formed by the seat rails, extends in the longitudinal orientation of the seat rails and is configured to receive and retain an actuation assembly inserted internally into the rail profile.

5. The longitudinal adjustment device as claimed in claim 1, wherein an outer connection region of the adapter protrudes from the rail profile perpendicularly with respect to the longitudinal orientation of the seat rails and is configured to receive and retain an actuation assembly arranged externally on the rail profile.

6. The longitudinal adjustment device as claimed in claim 1, wherein the adapter is configured as a force transmission element such that a rotation point of the actuation assembly is formed in the area of the seat-side seat rail.

7. The longitudinal adjustment device as claimed in claim 6, wherein the rotation point lies in the edge area of the seat-side seat rail.

8. The longitudinal adjustment device as claimed in claim 1, wherein the adapter is arranged pivotably on the seat-side seat rail.

9. The longitudinal adjustment device as claimed in claim 1, wherein the respective actuation assembly is arranged with spring loading on the adapter or on the seat-side seat rail.

10. The longitudinal adjustment device as claimed in claim 1, wherein the adapter is configured as a partially open or closed and/or one-part or multi-part profile, from which at least one connection arm extends perpendicularly.

11. The longitudinal adjustment device as claimed in claim 1, wherein the adapter is configured as a double-walled shaped part.

12. The longitudinal adjustment device as claimed in claim 11, wherein the adapter is configured such that the walls of the shaped part bear on each other in the connection region.

13. The longitudinal adjustment device as claimed in claim 11, wherein the adapter is configured in such a way that the walls are spaced apart from each other in the area of the unlocking element.

14. The longitudinal adjustment device as claimed in claim 11, wherein the adapter in the connection region is configured such that, from the walls bearing on each other, at least two tab-shaped retaining lugs protrude outward away from each other.

15. A vehicle seat comprising a longitudinal adjustment device comprising:
at least one vehicle secured seat rail secured to the vehicle;
at least one seat secured seat rail secured to the seat, the at least one vehicle secured seat rail and the at least one seat secured seat rail mutually engaging to form a rail profile and being movable relative to each other in a longitudinal direction;
at least one rail lock with which the seat rails are lockable to each other;
at least one actuation assembly for actuating the rail lock;
at least one adapter arranged between the actuation assembly and the rail lock, said adapter being configured as a force transmission element such that at least one connection region of the adapter protrudes from the rail profile to connect the actuation assembly; and
at least one integrated unlocking element provided on the adapter to unlock the rail lock, said unlocking element being configured to actively engage in the rail lock to unlock same, upon actuation of the actuation assembly.

16. The vehicle seat as claimed in claim 15, wherein the adapter is arranged inside the rail profile formed by the seat rails and protrudes at least in parts from the rail profile.

17. The vehicle seat as claimed in claim 15, wherein the adapter has at least two connection regions, which are each configured corresponding to one of differently configured actuation assemblies.

18. The vehicle seat as claimed in claim 15, wherein an inner connection region of the adapter is arranged inside the rail profile formed by the seat rails, extends in the longitudinal orientation of the seat rails and is configured to receive and retain an actuation assembly inserted internally into the rail profile.

19. The vehicle seat as claimed in claim 15, wherein an outer connection region of the adapter protrudes from the rail profile perpendicularly with respect to the longitudinal orientation of the seat rails and is configured to receive and retain an actuation assembly arranged externally on the rail profile.

20. The vehicle seat as claimed in claim 15, wherein the adapter is configured as a force transmission element in such that a rotation point of the actuation assembly is formed in the area of the seat-side seat rail.
